(19) United States
(12) Patent Application Publication
(10) Pub. No.: US 2023/0100122 A1
(43) Pub. Date: Mar. 30, 2023

(54) PHOTOELECTRIC CONVERSION MODULE PLUG AND OPTICAL CABLE

(71) Applicant: NITTO DENKO CORPORATION, Osaka (JP)

(72) Inventors: Naoyuki TANAKA, Osaka (JP); Koya OSUKA, Osaka (JP)

(73) Assignee: NITTO DENKO CORPORATION, Osaka (JP)

(21) Appl. No.: 17/913,735

(22) PCT Filed: Mar. 25, 2021
(86) PCT No.: PCT/JP2021/012585

§ 371 Date: Sep. 22, 2022

(30) Foreign Application Priority Data
Mar. 31, 2020 (JP) 2020-064189

(51) Int. Cl. G02B 6/42

(52) U.S. Cl. CPC G02B 6/4292

(57) ABSTRACT

Provided is a photoelectric conversion module plug that includes a photoelectric hybrid board, a circuit board, an optical connector, and a plug case that houses them. At least a part of the photoelectric hybrid board faces the circuit board. The plug case has a thickness T2 in a facing direction between the photoelectric hybrid board and the circuit board. The ratio of the thickness T1 of the optical connector with respect to the thickness T2 of the plug case is 30% or more. The plug case has side walls having uneven region portions respectively and at least a part of the optical connector is located between the uneven region portions. An optical cable according to the present invention includes the module plugs and an optical cable that optically connects between these module plugs.

### TECHNICAL FIELD

The present invention relates to a photoelectric conversion module plug and an optical cable.

### BACKGROUND ART

Conventionally, an optical cable having plugs for connection to devices at both ends is used for signal transmission such as a High-Definition Multimedia Interface (HDMI) transmission. Each of the plugs incorporates a photoelectric conversion module. The photoelectric conversion module includes an optical transmission line connected to an optical fiber in the optical cable through an optical connector, an electric circuit, an optical element (light emitting element, light receiving element) in charge of photoelectric conversion therebetween, and a plug case that houses them. A technique relating to the photoelectric conversion module is disclosed in, for example, Patent Document 1 below.

### CITATION LIST

### Patent Document

Patent Document 1: Japanese Unexamined Patent Publication No. 2017-198950

### SUMMARY OF THE INVENTION

### Problem to be Solved by the Invention

The conventional type photoelectric conversion module may include a lens block having a deflection mirror surface as an optical component that bends an optical path by 90° between the optical transmission line and the optical element to optically connect therebetween. In the photoelectric conversion module, the optical element is mounted on the circuit board, and the lens block is also mounted on the circuit board so that its deflection mirror surface is opposed to the optical element.

In the meantime, since thinning of devices such as televisions, notebook computers, and the like to which a photoelectric conversion module-incorporating plug is connected is progressing, there is a demand for thinning the photoelectric conversion module-incorporating plug as well.

However, thinning of the plug that incorporates the photoelectric conversion module including the lens block is difficult to be achieved because the lens block is bulky.

Further, the thinner a plug case of the photoelectric conversion module-incorporating plug is, the more easily it is distorted, for example, when the plug case is grasped by fingertips of a worker during connection work of the plug to a device. If the distorted plug case causes distortion in an optical transmission line in the plug, appropriate optical transmission cannot be achieved.

The present invention provides a photoelectric conversion module plug suitable for achieving thinning while securing optical transmission reliability, and an optical cable provided with the same.

### Means for Solving the Problem

The present invention [1] includes a photoelectric conversion module plug including a circuit board; a photoelectric hybrid board disposed so that at least a part of the photoelectric hybrid board faces the circuit board; an optical connector for optically connecting the photoelectric hybrid board to an optical fiber; and a plug case that houses the circuit board, the photoelectric hybrid board, and the optical connector, the photoelectric conversion module plug having a thickness in a facing direction between the circuit board and the photoelectric hybrid board, in which a ratio of a thickness of the optical connector with respect to a thickness of the plug case is 30% or more, the plug case has a first side wall and a second side wall that are spaced apart from each other in a direction transverse to a direction of the thickness, the first side wall has a first uneven region portion, the second side wall has a second uneven region portion, and the first and second uneven region portions are disposed so that at least a part of the optical connector is located between the first and second uneven region portions.

The photoelectric conversion module plug includes the photoelectric hybrid board as described above. The configuration in which the photoelectric conversion module plug is equipped with the photoelectric hybrid board including an optical waveguide (part of an optical transmission line) and an optical element optically connected thereto is suitable for avoiding use of a bulky lens block for optical coupling between the optical transmission line and the optical element, and is therefore suitable for thinning of the plug. This configuration is suitable for thinning the plug, specifically, by reducing the thickness of the plug case so that the ratio of the thickness of the optical connector with respect to the thickness of the plug case is 30% or more.

When a worker handles the photoelectric conversion module plug during connection work of this plug to a device, the uneven region portions in the first and second side walls of the plug case tend to serve as a mark on which the worker places a fingertip, and thus tend to encourage the worker to grasp the plug in its width direction by placing a fingertip on the uneven region portions in the respective side walls of the plug case. This configuration is suitable for reducing a chance of grasping the plug in its thickness direction, and is therefore suitable for suppressing occurrence of distortion in the optical transmission line in the thin plug. The uneven region portions in the respective side walls of the plug case are likely to produce sufficient friction on the fingertips of the worker who handles the plug, and are therefore also suitable for easily grasping the plug by the fingertips even though the plug is thin.

In addition, in the photoelectric conversion module plug, even though distortion occurs in the plug case when this plug is grasped at the uneven region portions in the respective side walls of the plug case, such distortion hardly induces distortion of the optical transmission line in the plug case. This is because in the photoelectric conversion module plug, the uneven region portions are disposed in the respective side walls of the plug case so that at least a part of the optical connector (easily securing high structural strength and having a thickness of which the ratio with respect to the thickness of the plug case is 30% or more) is located between the uneven region portions. The photoelectric conversion module plug is suitable for securing optical transmission reliability.

The present invention [2] includes the photoelectric conversion module plug described in [1], in which a wall surface of the first side wall is formed with a recess in the first uneven region portion.

The present invention [3] includes the photoelectric conversion module plug described in [1] or [2], in which a wall surface of the second side wall is formed with a recess in the second uneven region portion.

The present invention [4] includes the photoelectric conversion module plug described in any one of the above-described [1] to [3], in which a wall surface of the first side wall is formed with a protrusion in the first uneven region portion.

The present invention [5] includes the photoelectric conversion module plug described in any one of the above-described [1] to [4], in which a wall surface of the second side wall is formed with a protrusion in the second uneven region portion.

The present invention [6] includes an optical cable including a first photoelectric conversion module plug according to any one of the above-described [1] to [5]; a second photoelectric conversion module plug according to in any one of the above-described [1] to [5]; and an optical fiber-incorporating cable that optically connects between the first and second photoelectric conversion module plugs.

### BRIEF DESCRIPTION OF THE DRAWINGS

FIG. 1 is a plan view of an embodiment of a photoelectric conversion module plug according to the present invention.

FIG. 2 is a perspective plan view of a part of the photoelectric conversion module plug shown in FIG. 1.

FIG. 3 is a cross-sectional view of the photoelectric conversion module plug shown in FIG. 1, taken along line III-III.

FIG. 4 is a partially enlarged cross-sectional view of an example of the photoelectric conversion module.

FIGS. 5A to 5C show a modification of a plug case: FIG. 5A shows a configuration having an uneven region portion in which a side wall of the plug case has a recess having a triangular shape in plain view; FIG. 5B shows a configuration having an uneven region portion in which the side wall of the plug case has a recess having a saw blade shape in plan view; and FIG. 5C shows a configuration having an uneven region portion in which the side wall of the plug case has a recess having a rectangular shape in plan view.

FIGS. 6A to 6D show another modification of the plug case: FIG. 6A shows a configuration having an uneven region portion in which the side wall of the plug case has a protrusion having a circular arc shape in plan view; FIG. 6B shows a configuration having an uneven region portion in which the side wall of the plug case has a protrusion having a triangular shape in plan view; FIG. 6C shows a configuration having an uneven region portion in which the side wall of the plug case has a protrusion having a saw blade shape in plan view; and FIG. 6D shows a configuration having an uneven region portion in which the side wall of the plug case has a protrusion having a rectangular shape in plan view.

FIG. 7 is a partially enlarged cross-sectional view of another example of the photoelectric conversion module.

FIG. 8 is a partially enlarged cross-sectional view of another example of the photoelectric conversion module.

FIG. 9 is a conceptual configuration diagram of an embodiment of an optical cable according to the present invention.

### DESCRIPTION OF THE EMBODIMENTS

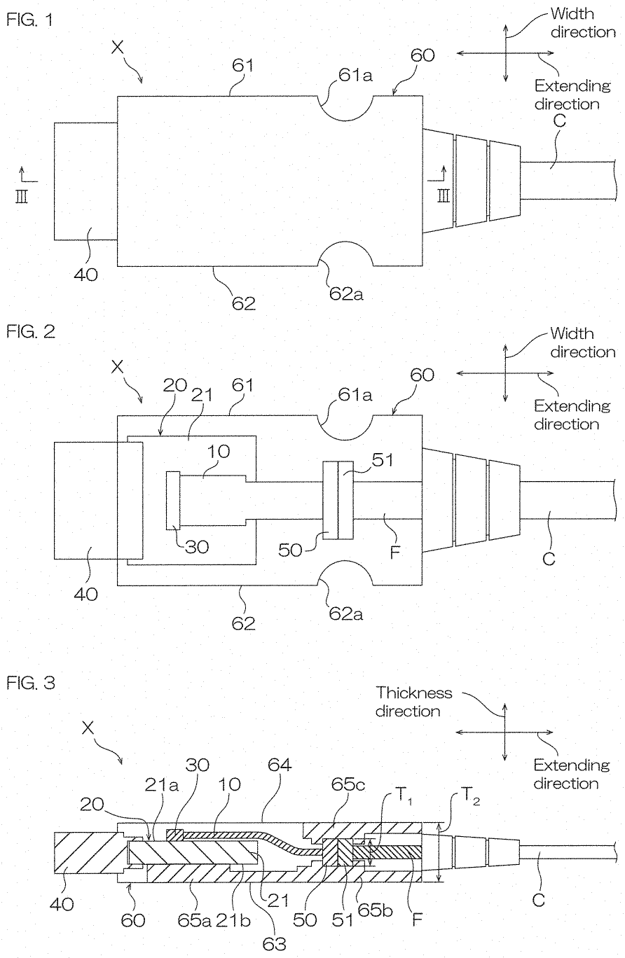

FIGS. 1 to 3 show a module plug X according to an embodiment of the present invention. FIG. 1 is a plan view of the module plug X, and FIG. 2 is a perspective plan view of a part of the module plug X (showing an interior of the module plug X in perspective of a plug case 60 to be described later). FIG. 3 is a cross-sectional view of the module plug X shown in FIG. 1, taken along line III-III.

The module plug X is a photoelectric conversion module plug including a photoelectric hybrid board 10, a circuit board 20, an FPC connector 30, an electrical connector 40, an optical connector 50, and a plug case 60. The module plug X is an element that is attached to a distal end of an optical fiber cable C for signal transmission, to be connected to a receptacle included in a device where a signal is transmitted/received through the optical fiber cable C. The module plug X is configured as a transmitting module having a transmitting function of converting an electrical signal from a device into an optical signal to be output to an optical fiber cable, a receiving module having a receiving function of converting an optical signal from an optical fiber cable into an electrical signal to be output to a device, or a transmitting/receiving module having both functions.

As shown in FIGS. 1 and 2, the module plug X has a shape extending in one direction and has a width in a direction orthogonal to the extending direction. In the module plug X, the electrical connector 40 and the optical connector 50 are disposed at a distant in the extending direction, and the photoelectric hybrid board 10 and the circuit board 20 are disposed therebetween. The photoelectric hybrid board 10 and the circuit board 20 are partially overlapped in the extending direction. Specifically, at least a part of the photoelectric hybrid board 10 (in the present embodiment, an electrical connector 40-side portion thereof in the extending direction) and the circuit board 20 are overlapped in the extending direction. The photoelectric hybrid board 10 and the circuit board 20 are connected via the FPC connector 30. As shown in FIG. 3, in the region where the photoelectric hybrid board 10 and the circuit board 20 are overlapped in the extending direction, the photoelectric hybrid board 10 and the circuit board 20 face each other, or are in opposed relation, and the module plug X has a thickness in a direction, facing direction, in which the photoelectric hybrid board 10 and the circuit board 20 are opposed to each other.

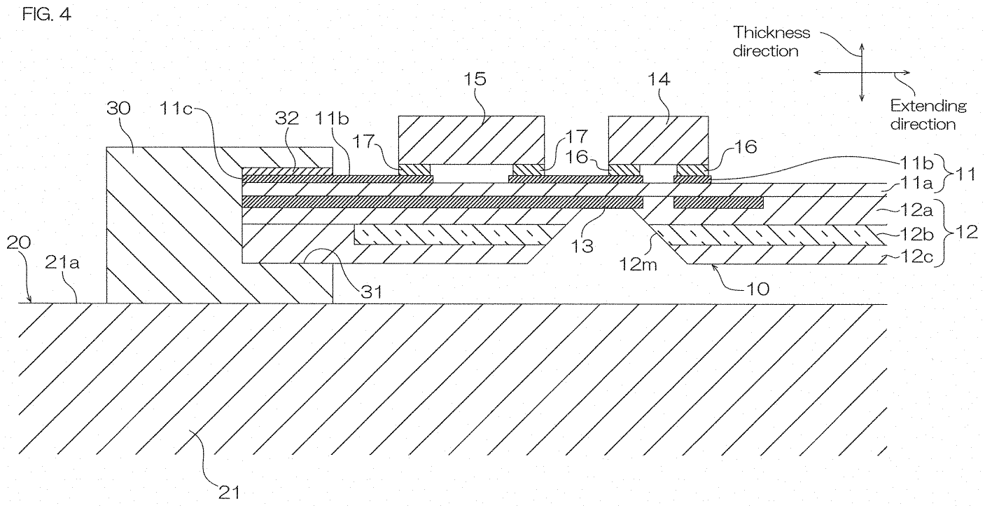

As shown in FIG. 4, the photoelectric hybrid board 10 includes a flexible wiring board 11, an optical waveguide portion 12, a metal supporting layer 13, an optical element 14, and a circuit element 15. In the present embodiment, the flexible wiring board 11 in the photoelectric hybrid board 10 faces away from the circuit board 20, and the optical waveguide portion 12 is located on the circuit board 20 side in the photoelectric hybrid board 10. The metal supporting layer 13 is located between the flexible wiring board 11 and the optical waveguide portion 12 in the thickness direction. The optical element 14 and the circuit element 15 are mounted on the flexible wiring board 11.

The flexible wiring board 11 includes a flexible insulating base material 11a and a wiring pattern 11b patterned thereon. The wiring pattern 11b includes terminal portions 11c located at an end of the flexible wiring board 11 in the extending direction. Examples of a constituent material of the flexible insulating base material 11a include polyimide. The flexible insulating base material 11a has a thickness of, for example, 5 μm or more and, for example, 50 μm or less. Examples of a constituent material of the wiring pattern 11b include copper.

The optical waveguide portion 12 includes an under-cladding layer 12a, a core 12b, and an over-cladding layer 12c, and has a laminated structure in which these layers are laminated in the thickness direction. The under-cladding layer 12a is located on the flexible wiring board 11 side in the thickness direction. The core 12 is located between the under-cladding layer 12a and the over-cladding layer 12c. The core 12b is provided on each optical element 14. The core 12b has a mirror surface 12m. The mirror surface 12m is inclined at an angle of 45° to an optical axis of light propagating through the core 12b, and bends an optical path by 90° to optically connect between the core 12b and the optical element 14.

The core 12b has a higher refractive index than the under-cladding layer 12a and the over-cladding layer 12c, and constitutes an optical transmission line itself. Examples of constituent materials of the under-cladding layer 12a, the core 12b, and the over-cladding layer 12c include transparent flexible resin materials such as epoxy resin, acrylic resin, silicone resin, and the like, and epoxy resin is preferably used in view of optical signal transmission quality.

The under-cladding layer 12a has a thickness of, for example, 2 μm or more, preferably 10 μm or more and, for example, 600 μm or less, preferably 40 μm or less. The core 12b has a thickness of, for example, 5 μm or more, preferably 30 μm or more and, for example, 100 μm or less, preferably 70 μm or less. The over-cladding layer 12c has a thickness of, for example, 2 μm or more, preferably 5 μm or more and, for example, 600 μm or less, preferably 40 μm or less.

The metal supporting layer 13 is an element reinforcing a region on one end side in the extending direction of the photoelectric hybrid board 10, and is located between the flexible wiring board 11 and the optical waveguide portion 12 in the thickness direction. The metal supporting layer 13 is provided, for example, in a region including a region where the optical element 14 and the circuit element 15 are mounted on the photoelectric hybrid board 10. Examples of a constituent material of the metal supporting layer 13 include metals such as stainless steel, aluminum, copper-beryllium, copper, silver, and the like. The metal supporting layer 13 has a thickness of preferably 3 μm or more, more preferably 10 μm or more, and preferably 100 μm or less, more preferably 50 μm or less.

The optical element 14 is a light emitting element for converting an electrical signal into an optical signal, or a light receiving element for converting an optical signal into an electrical signal. The optical element 14 is disposed opposite to the mirror surface 12m at a position corresponding to the mirror surface 12m on the photoelectric hybrid board 10, and is electrically connected to the wiring pattern 11b of the flexible wiring board 11 by bonding with a bonding material 16 such as a bump. When the module plug X is a transmitting module, the module plug X includes one or two or more light emitting elements as the optical element 14. When the module plug X is a receiving module, the module plug X includes one or two or more light receiving elements as the optical element 14. When the module plug X is a transmitting/receiving module, the module plug X includes one or two or more light emitting elements and one or two or more light receiving elements, as the optical element 14.

The light emitting element is, for example, a laser diode such as a vertical cavity surface emitting laser (VCSEL) and the like. The light receiving element is, for example, a photodiode. Examples of the photodiode include a p-intrinsic-n (PIN) type photodiode, a metal semiconductor metal (MSM) photodiode, and an avalanche photodiode.

The circuit element 15 is electrically connected to the wiring pattern 11b of the flexible wiring board 11 by bonding with a bonding material 17 such as a bump. When the optical element 14 is a light emitting element, the circuit element 15 constitutes a drive circuit for driving the optical element 14 of the light emitting element. When the optical element 14 is a light receiving element, the circuit element 15 is a transimpedance amplifier (TIA) for amplifying an output current from the optical element 14 of the light receiving element.

As shown in FIG. 3, the circuit board 20 include a substrate 21 and a circuit (not illustrated) on the substrate 21. The substrate 21 has a surface 21a and a surface 21b facing away from the surface 21a. Examples of a constituent material of the substrate 21 include hard materials such as a glass fiber-reinforced epoxy resin and the like. The circuit includes an integrated circuit and a wiring pattern. The wiring pattern includes a plurality of electrical connector-side terminals on the surface 21a. The circuit is formed on the surface 21a, or formed on the surface 21a and the surface 21b. The wiring pattern on the surface 21a and the wiring pattern on the surface 21b are electrically connected through a via hole (not illustrated) penetrating the substrate 21 in its thickness direction.

As shown in FIG. 4, the FPC connector 30 is an element for electrically connecting between the photoelectric hybrid board 10 and the circuit board 20, and is disposed on the surface 21a of the circuit board 20. The FPC connector 30 has a receiving portion 31 (connection port), has terminals 32 in the receiving portion 31, and has conductive paths (not illustrated) for electrically connecting between the terminals 32 and a wiring pattern on the circuit board 20 side. One end in the extending direction of the photoelectric hybrid board 10 is fitted to the receiving portion 31 of the FPC connector 30, and the terminal portions 11c on the photoelectric hybrid board 10 side and the terminals 32 on the FPC connector 30 side abut against each other. Through the FPC connector 30, the photoelectric hybrid board 10 and the circuit board 20 are electrically connected.

The electrical connector 40 is an element for electrically connecting between a device not included in the drawing and the module plug X by being inserted into a receptacle of the device. The electrical connector 40 has a plurality of terminals (not illustrated) for external connection. Each of the terminals is electrically connected to a corresponding terminal on the electrical connector side of the circuit board 20.

As shown in FIG. 3, the optical connector 50 is a part that is coupled to the optical connector 51 of the optical fiber cable C to optically connect between the optical waveguide portion 12 of the photoelectric hybrid board 10 and the optical fiber F of the optical fiber cable C. The optical connector 50 is attached to the end of the photoelectric hybrid board 10. The optical connector 51 is attached to the end of the optical fiber F in the optical fiber cable C. The optical connectors 50 and 51 are assembled in the plug case 60 so that the core 12b of the optical waveguide portion 12 in the photoelectric hybrid board 10 and a wire of the optical fiber F abut against each other in one-to-one correspondence.

The optical connector 50 has a thickness T₁. The thickness T₁ is, for example, 1 mm or more and, for example, 3 mm or less, preferably 2.5 mm or less.

When the optical fiber cable C having the module plug X attached to its distal end has a hybrid structure in which the optical fiber F and an electric wire are used in combination for transmitting/receiving a signal, the electric wire incorporated in the optical fiber cable C passes through the optical connectors 50 and 51, and is then electrically connected to, for example, the wiring pattern provided on the surface 21b side of the circuit board 20.

As shown in FIGS. 1 and 2, the plug case 60 has a side wall 61 and a side wall 62 that are spaced apart from each other in the width direction, and has a first wall 63 and a second wall 64 that are spaced apart from each other in the thickness direction.

The side wall 61 has an uneven region portion 61a, and the side wall 62 has an uneven region portion 62a. The uneven region portions 61a and 62a are disposed at a position closer to the optical fiber cable C than to the electrical connector 40 in the extending direction, and are disposed so that at least a part (preferably the whole) of the above-described optical connector 50 is located between the uneven region portions 61a and 62a. In the present embodiment, the circuit board 20 is not located between the uneven region portions 61a and 62a. In the uneven region portions 61a and 62a of the present embodiment, the outer surface of each of the side walls 61 and 62 is formed with a recess recessed toward the inner side in the width direction. The recess has a curved surface recessed in a circular arc shape in plan view from each of the side walls 61 and 62 toward the inner side in the width direction. This plug case 60 is, for example, a resin case or a metal case.

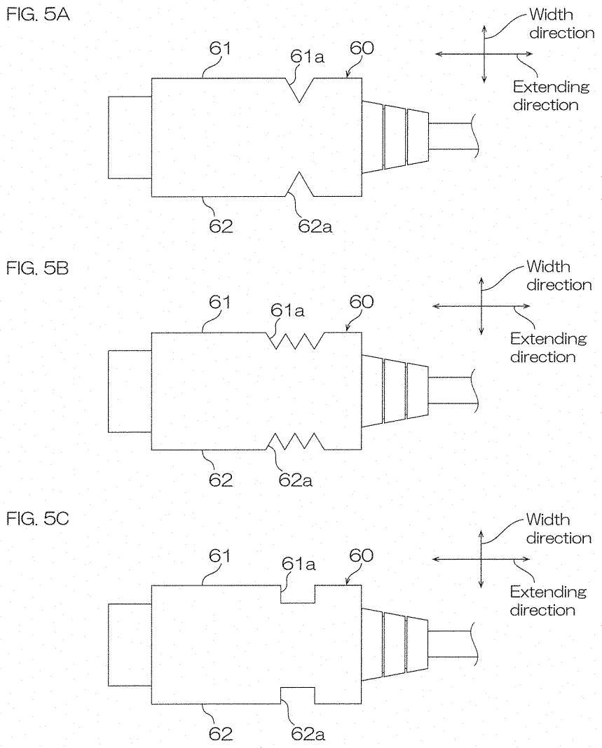

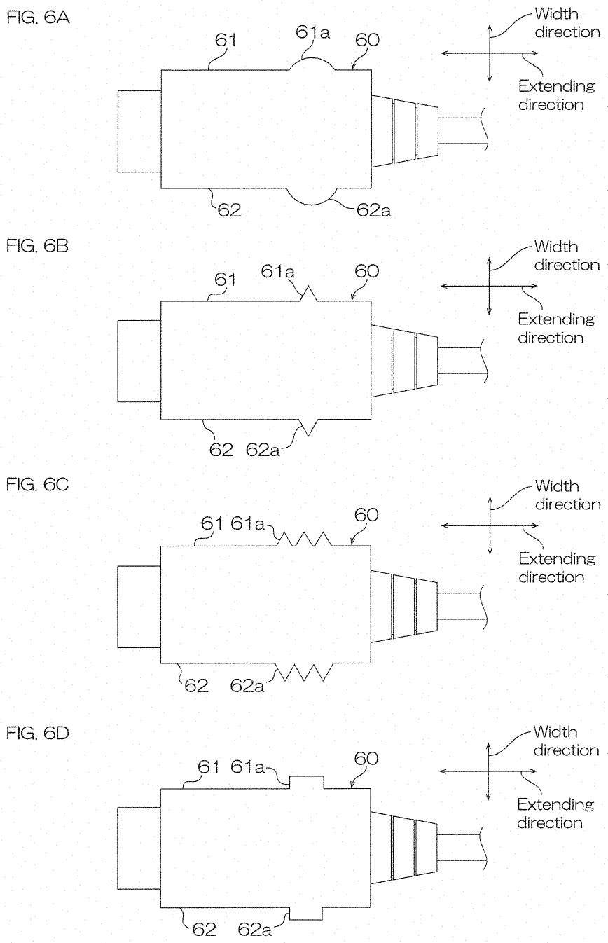

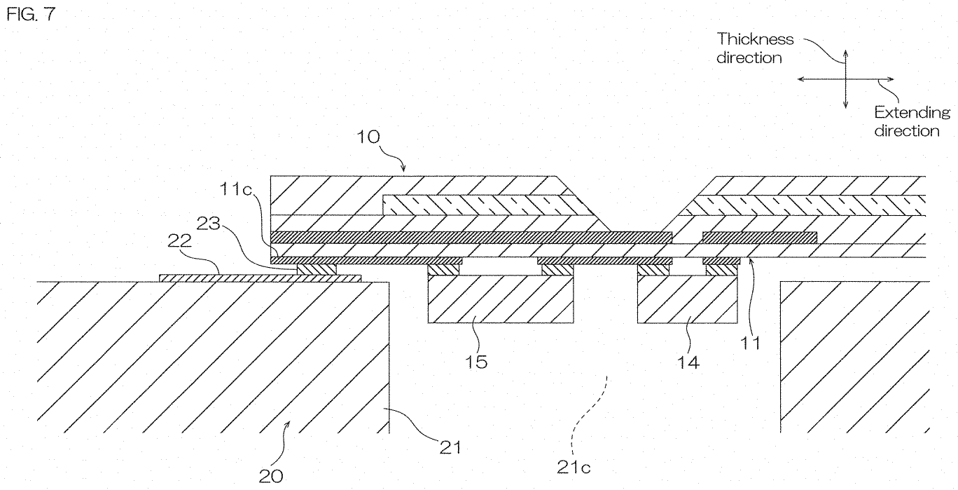

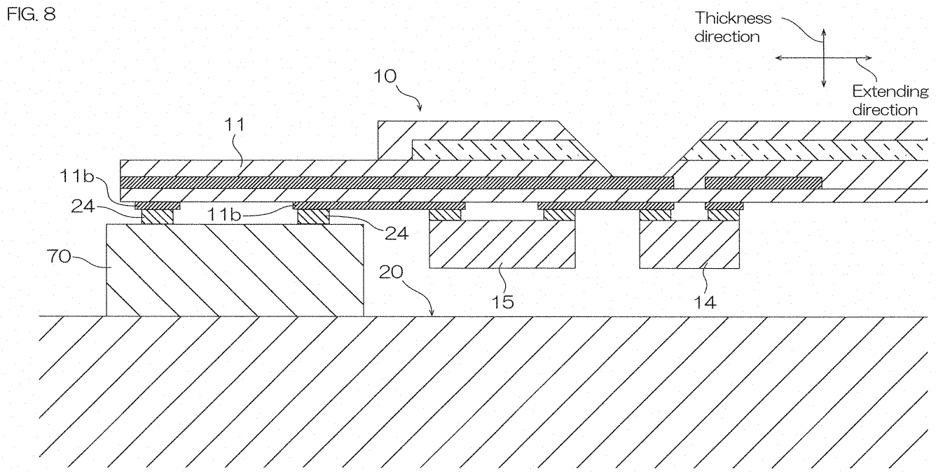

The plug case 60 may have the uneven region portions 61a and 62a as shown in FIG. 5 or the uneven region portions 61a and 62a as shown in FIG. 6, instead of the uneven region portions 61a and 62a as shown in FIGS. 1 and 2.

In the uneven region portions 61a and 62a shown in FIG. 5, the outer surface of each of the side walls 61 and 62 is formed with a recess recessed toward the inner side in the width direction. Specifically, in the uneven region portions 61a and 62a shown in FIG. 5A, the outer surface of each of the side walls 61 and 62 is formed with a recess having a triangular shape in plan view recessed toward the inner side in the width direction. In the uneven region portions 61a and 62a shown in FIG. 5B, the outer surface of each of the side walls 61 and 62 is formed with a recess having a saw blade shape in plan view recessed toward the inner side in the width direction. In the uneven region portions 61a and 62a shown in FIG. 5C, the outer surface of each of the side walls 61 and 62 is formed with a recess having a rectangular shape in plan view recessed toward the inner side in the width direction.

In the uneven region portions 61a and 62a shown in FIG. 6, the outer surface of each of the side walls 61 and 62 is formed with a protrusion protruded toward the outer side in the width direction. Specifically, in the uneven region portions 61a and 62a shown in FIG. 6A, the outer surface of each of the side walls 61 and 62 is formed with a protrusion having a circular arc shape in plan view protruded toward the outer side in the width direction. In the uneven region portions 61a and 62a shown in FIG. 6B, the outer surface of each of the side walls 61 and 62 is formed with a protrusion having a triangular shape in plan view protruded toward the outer side in the width direction. In the uneven region portions 61a and 62a shown in FIG. 6C, the outer surface of each of the side walls 61 and 62 is formed with a protrusion having a saw blade shape in plan view protruded toward the outer side in the width direction. In the uneven region portions 61a and 62a shown in FIG. 6D, the outer surface of each of the side walls 61 and 62 is formed with a protrusion having a rectangular shape in plan view protruded toward the outer side in the width direction.

In the plug case 60, as shown in FIG. 3, support structures 65a, 65b, and 65c are provided. The support structure 65a protrudes from the first wall 63 of the plug case 60 towards the second wall 64 of the plug case 60. The circuit board 20 is bonded to the support structure 65a with, for example, an adhesive. The support structure 65b protrudes from the first wall 63 of the plug case 60 toward the second wall 64 thereof, and the support structure 65c protrudes from the second wall 64 of the plug case 60 toward the first wall 63 thereof in a position opposed to the support structure 65b. The support structures 65b and 65c have a structure capable of sandwiching the optical connectors 50 and 51 in the thickness direction, and the optical connectors 50 and 51 are sandwiched between these support structures 65b and 65c. The support structures 65a, 65b, and 65c may be integrated with the plug case 60 or may be provided as separate bodies from the plug case 60. The plug case 60 and the support structures 65a, 65b, and 65c may be made of resin or metal. When the plug case 60 and the support structures 65a, 65b, and 65c are separate bodies, their constituent materials may be the same or different.

The plug case 60 has a thickness T₂. The thickness T₁ of the above-described optical connector with respect to the thickness T₂ of the plug case 60 is 30% or more, preferably 35% or more, more preferably 40% or more. The thickness T₂ of the plug case 60 is, for example, 9 mm or less, preferably 7 mm or less, more preferably 5 mm or less.

The module plug X includes the photoelectric hybrid board 10 as described above. The configuration in which the module plug X is equipped with the photoelectric hybrid board 10 including the optical waveguide portion 12 (part of the optical transmission line) and the optical element 14 optically connected thereto is suitable for avoiding use of a bulky lens block for optical coupling between the optical transmission line and the optical element 14, and is therefore suitable for thinning of the module plug X. This configuration is suitable for thinning the module plug X, specifically, by reducing the thickness of the plug case 60 so that a ratio of the thickness of the optical connector 50 with respect to the thickness of the plug case 60 is 30% or more.

When a worker handles the module plug X during connection work of the module plug X to a device, the uneven region portions 61a and 62a in the side walls 61 and 62 of the plug case 60 tend to serve as a mark on which the worker places a fingertip, and thus tend to encourage the worker to grasp the module plug X in its width direction by placing a fingertip on the uneven region portions 61a and 62a in the side walls 61 and 62, respectively, of the plug case 60. This configuration is suitable for reducing a chance of grasping the module plug X in its thickness direction, and is therefore suitable for suppressing occurrence of distortion in the optical transmission line in the thin module plug X. The uneven region portions 61a and 62a in the side walls 61 and 62, respectively, of the plug case 60 are likely to produce sufficient friction on the fingertips of the worker who handles the plug, and are therefore also suitable for easily grasping the module plug X by the fingertips even though the module plug X is thin.

In addition, in the module plug X, even though distortion occurs in the plug case 60 when the module plug X is grasped at the uneven region portions 61a and 62a in the side walls 61 and 62, respectively, of the plug case 60, such distortion hardly induces distortion of the optical transmission line in the plug case 60. This is because in the module plug X, the uneven region portions 61a and 62a are disposed in the side walls 61 and 62, respectively, of the plug case 60 so that at least parts of the optical connectors 50 and 51 (easily securing high structural strength and having the thickness T₁ 30% or more with respect to the thickness T₂ of the plug case 60) are located between the uneven region portions 61a and 62a. Along with this, the support structures 65b and 65c sandwiching the optical connectors 50 and 51 as described above are useful for reinforcing the inside of the plug case 60 around the optical connectors 50 and 51, and therefore serve to suppress the above-described distortion of the optical transmission line caused by distortion of the plug case 60. The module plug X is suitable for securing optical transmission reliability.

Accordingly, the module plug X is suitable for achieving thinning while securing optical transmission reliability.

As shown in FIG. 7, the module plug X may have the photoelectric hybrid board 10 flip-chip mounted on the circuit board 20, without the FPC connector 30. In this case, the substrate 21 having a predetermined opening 21c formed therein is used, and for example, the terminal portion 11c of the flexible wiring board 11 in the photoelectric hybrid board 10 is bonded to a terminal 22 for flip chip mounting provided on the circuit board 20 with a bonding material 23 such as a bump. The mounting embodiment in which the flexible wiring board 11 side having the optical element 14 and the circuit element 15 mounted thereon in the photoelectric hybrid board 10 is opposed to the circuit board 20 is preferable in view of thinning of the module plug X.

In the module plug X, as shown in FIG. 8, the wiring pattern 11b of the flexible wiring board 11 in the photoelectric hybrid board 10 and a wiring pattern (not illustrated) on the circuit board 20 may be electrically connected through a connector 70 instead of the FPC connector 30. The connector 70 has a conductive path (not illustrated) electrically connected to the wiring pattern on the circuit board 20 side, and the conductive path and the wiring pattern 11b of the flexible wiring board 11 are bonded with a bonding material 24 such as a bump. The connector 70 is, for example, a connector for board-to-board (that is, a B-to-B connector). The mounting embodiment in which the flexible wiring board 11 side having the optical element 14 and the circuit element 15 mounted thereon in the photoelectric hybrid board 10 is opposed to the circuit board 20 is preferable in view of thinning of the module plug X.

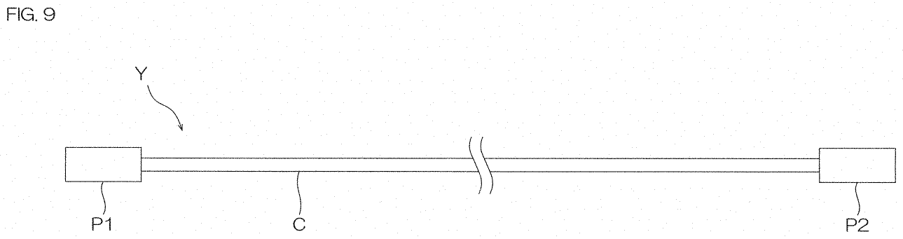

FIG. 9 is a conceptual configuration diagram of an optical cable Y according to an embodiment of the present invention. The optical cable Y includes an optical fiber cable C, and plugs P1 and P2.

The optical fiber cable C is, for example, a cable for signal transmission such as HDMI transmission. The optical fiber cable C has a length of, for example, from 2 to 200 m. The optical fiber cable C is an optical fiber-incorporating cable including at least an optical fiber as a signal transmission line. The optical fiber cable C may have a hybrid structure in which an optical fiber and an electric wire are used in combination for transmitting/receiving a signal.

The plugs P1 and P2 are each formed by a module plug X. One of the plugs P1 and P2 is a module plug X that has a configuration of a transmitting module, and the other is a module plug X that has a configuration of a receiving module. Alternatively, the plugs P1 and P2 are both module plugs X that have a configuration of a transmitting/receiving module.

In the optical cable Y, the plugs P1 and P2 can obtain a technical effect similar to that described above relating to the module plug X.

### INDUSTRIAL APPLICABILITY

The photoelectric conversion module plug of the present invention is available for signal transmission such as HDMI transmission.

### DESCRIPTION OF REFERENCE NUMERALS

X module plug (photoelectric conversion module plug)
10 photoelectric hybrid board
11 flexible wiring board
11a flexible insulating base material
11b wiring pattern
12 optical waveguide portion
12a under-cladding layer
12b core
12c over-cladding layer
13 metal supporting layer
14 optical element
15 circuit element
20 circuit board
30 FPC connector
40 electrical connector
50, 51 optical connectors
60 plug case
61, 62 side walls
61a, 62b uneven region portions
F optical fiber
Y optical cable
X optical fiber cable (optical fiber-incorporating cable)
P1, P2 plugs (photoelectric conversion module plugs)

1. A photoelectric conversion module plug comprising:
a circuit board;
a photoelectric hybrid board disposed so that at least a part of the photoelectric hybrid board faces the circuit board;
an optical connector for optically connecting the photoelectric hybrid board to an optical fiber; and
a plug case that houses the circuit board, the photoelectric hybrid board, and the optical connector, the photoelectric conversion module plug having a thickness in a facing direction between the circuit board and the photoelectric hybrid board,
wherein a ratio of a thickness of the optical connector with respect to a thickness of the plug case is 30% or more,
the plug case has a first side wall and a second side wall that are spaced apart from each other in a direction transverse to a direction of the thickness,
the first side wall has a first uneven region portion,
the second side wall has a second uneven region portion, and
the first and second uneven region portions are disposed so that at least a part of the optical connector is located between the first and second uneven region portions.

2. The photoelectric conversion module plug according to claim 1, wherein a wall surface of the first side wall is formed with a recess in the first uneven region portion.

3. The photoelectric conversion module plug according to claim 1, wherein a wall surface of the second side wall is formed with a recess in the second uneven region portion.

4. The photoelectric conversion module plug according to claim 1, wherein a wall surface of the first side wall is formed with a protrusion in the first uneven region portion.

5. The photoelectric conversion module plug according to claim 1, wherein a wall surface of the second side wall is formed with a protrusion in the second uneven region portion.

6. An optical cable comprising:
the first photoelectric conversion module plug and the second photoelectric conversion module plug according to claim 1; and
an optical fiber-incorporating cable that optically connects between the first and second photoelectric conversion module plugs.
